(19) United States
(12) Patent Application Publication
(10) Pub. No.: US 2012/0290342 A1
(43) Pub. Date: Nov. 15, 2012

(54) PRODUCT LIFECYCLE MANAGEMENT TECHNIQUES

(75) Inventors: David J. Gower, Redmond, WA (US); Venkatraman Sarma Cherukupalli, Redmond, WA (US); Simon A. Floyd, Sammamish, WA (US); Osama I. Khan, Redmond, WA (US); Ryan C. Murphy, Bellevue, WA (US)

(73) Assignee: MICROSOFT CORPORATION, Redmond, WA (US)

(21) Appl. No.: 13/104,315

(22) Filed: May 10, 2011

(51) Int. Cl. G06Q 10/00

(52) U.S. Cl. 705/7.11

(57) ABSTRACT

Product lifecycle management techniques are described. In one or more implementations, a request is received from a user for information relating to product lifecycle management of a product associated with an enterprise and a job function of the user within the enterprise is determined. Information that relates to the product is collected and displayed in a user interface using a format and terminology that corresponds to the determined job function.

### BACKGROUND

Product Lifecycle Management (PLM) refers to the strategy a business employs to manage the conception, development, manufacturing, maintenance and retirement of a product. Product Lifecycle Management (PLM) software refers to a suite of applications that facilitate the business strategy by defining, managing, and relating information to new and existing products throughout their lifecycle. Consequently information managed by PLM software can relate to many aspects of the business including research, design, development, manufacturing, service, marketing and sales.

Traditional PLM applications are complex by nature as they specifically address needs of sophisticated users such as engineers but do so at the expense of casual users and non-engineering functions across the enterprise. Historically it has been difficult for software developers to create an easy to understand, easy to operate PLM application suite due to the constraints inherent in the software design and architecture therefore preventing them from adequately addressing the needs of users who span a large functional breadth and technical depth.

A common issue with PLM application suites and many other business applications is that authored information is trapped in a complicated structure with a unique taxonomy therefore making it “silo'ed” and largely inaccessible to other systems. Since business decisions often involve information from multiple sources, this forces a business user to access multiple systems and combine information manually in order to gain accurate or complete insights to enable optimal decision making.

### SUMMARY

Product lifecycle management techniques are described. In one or more implementations, a request is received from a user for information relating to the product lifecycle management of a product within an enterprise. The job function of the user within the enterprise is determined. Information that relates to the product is collected and displayed in a user interface using a format and terminology that corresponds to the determined job function.

In one or more implementations, product lifecycle management information is collected from multiple systems that relate to a business decision to be made regarding a product of an enterprise. A user interface is configured to use a format and terminology for the collected product lifecycle management information based on a specified job function of a user that is to make the business decision within the enterprise. The configured user interface furthermore presents a set of choices that are the specific result of the business decision.

In one or more implementations, data present within a Product Lifecycle Management application is extracted and stored in a form that makes it accessible to third party software, including search engines, thereby allowing it to be manipulated and combined to make it context and content sensitive.

In one or more implementations, the information presented to the user via the user interface can be manipulated, sorted, filtered and analyzed using both tabular row/column methods and graphical interpretations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform product lifecycle management techniques.

FIG. 2 is an illustration of an example user interface that includes product lifecycle management information for a product that originates in multiple systems and is assembled into a unified view for a user with a specific job function.

FIG. 3 is an illustration of an example user interface that includes an option to input a result of a business decision along with information that has a format and terminology chosen based on a job function of a user that is to make the decision.

FIG. 4 is an illustration of an example system that is operable to support one or more of the product lifecycle management techniques described herein.

FIG. 5 is a flow diagram depicting a procedure in an example implementation in which information is displayed in a user interface using a format and terminology that corresponds to a determined job function.

FIG. 6 is a flow diagram depicting a procedure in an example implementation in which an option is displayed along with product lifecycle management information to receive an input that describes a result of a business decision.

FIG. 7 illustrates various components of an example device that can be implemented as any type of computing device as described with reference to FIGS. 1 and 4 to implement embodiments of the techniques described herein.

### DETAILED DESCRIPTION

### Overview

Product lifecycle management techniques are typically employed by designers and manufacturers of products to manage information related to the lifecycle of a product. However, conventional techniques often involved access to a variety of different sources of information both inside and outside of an enterprise using a variety of different access techniques. Accordingly, these conventional techniques may involve navigation through a variety of different applications and sources of information as well as specialized knowledge of both how the hierarchies of information are arranged as well as how to interpret this information. Therefore, users of these conventional techniques were often forced to undergo significant amounts of training to interact with and understand these conventional product lifecycle management techniques.

In one or more implementations, product lifecycle management techniques are employed that may be used to aid users to find, visualize and navigate product lifecycle management information securely from multiple systems in a natural and contextual manner, which may be used improve decision making. For example, these techniques may utilize dynamic and indexed search queries of metadata contained within the line-of-business system and present the information in approximately real time (e.g., low latency) contextual view via a configurable user interface. Additionally, the user interface may be configured to employ a terminology and format that is based on a user's job function within an enterprise. In this way, a user's job function and work style may serve as a basis for display of the information in a user interface rather than conventional application boundaries and integrated systems that are designed around the information structure. It should be readily apparent, however, that the structure may also be leveraged in implementations described herein. Further discussion of these techniques may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

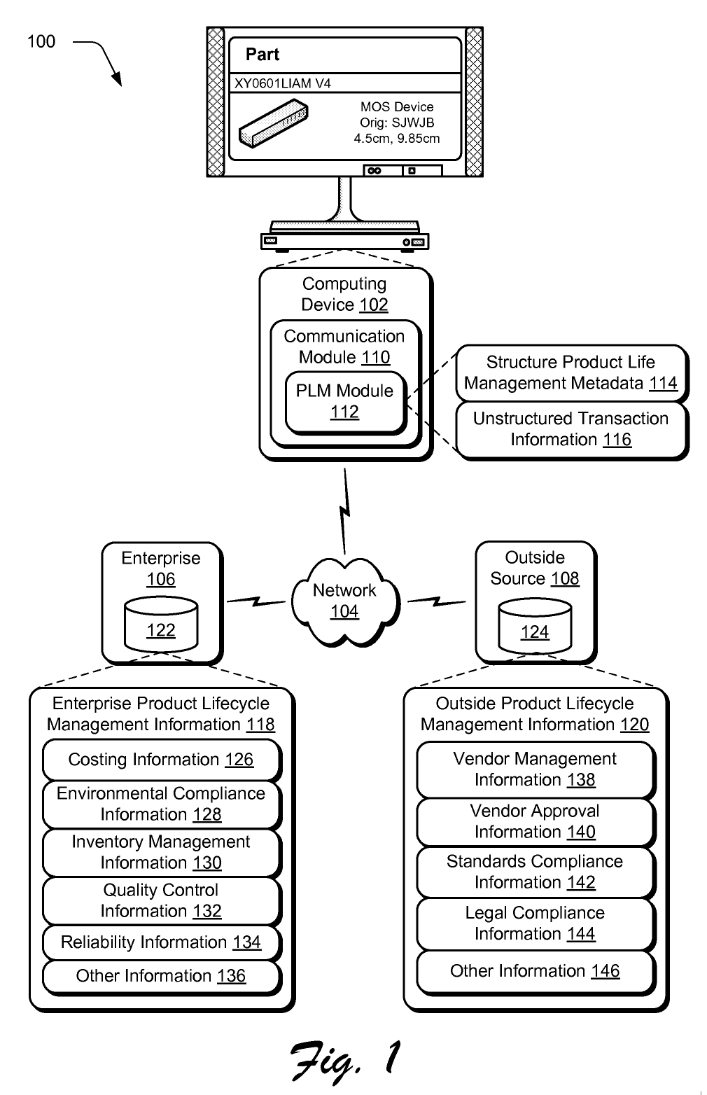

FIG. 1 is an illustration of an environment 100 in an example implementation that is operable to employ product lifecycle management techniques described herein. The illustrated environment 100 includes a computing device 102 that is communicatively coupled via a network 104 to an enterprise 106 and an outside source 108, which may be implemented by one or more computing devices that may be configured in a variety of ways.

For example, a computing device may be configured as a computer that is capable of communicating over the network 104, such as a desktop computer, a mobile station, an entertainment appliance, a set-top box communicatively coupled to a display device, a wireless phone, a game console, and so forth. Thus, the computing device may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations (e.g., as performed by the enterprise 106 or outside source 108), a remote control and set-top box combination, an image capture device and a game console configured to capture gestures, and so on.

Although the network 104 is illustrated as the Internet, the network may assume a wide variety of configurations. For example, the network 104 may include a wide area network (WAN), a local area network (LAN), a wireless network, a public telephone network, an intranet, and so on. Further, although a single network 104 is shown, the network 104 may be configured to include multiple networks. For example, the computing device 102 may be communicatively coupled as part of the enterprise 106 using an intranet and connected to the outside source 108 via an Internet. A variety of other examples are also contemplated.

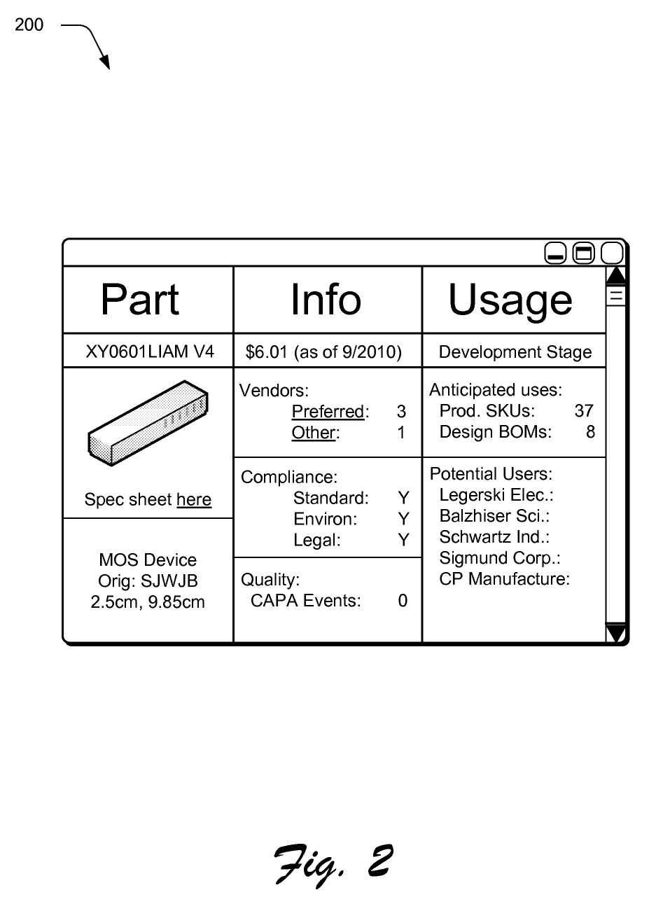

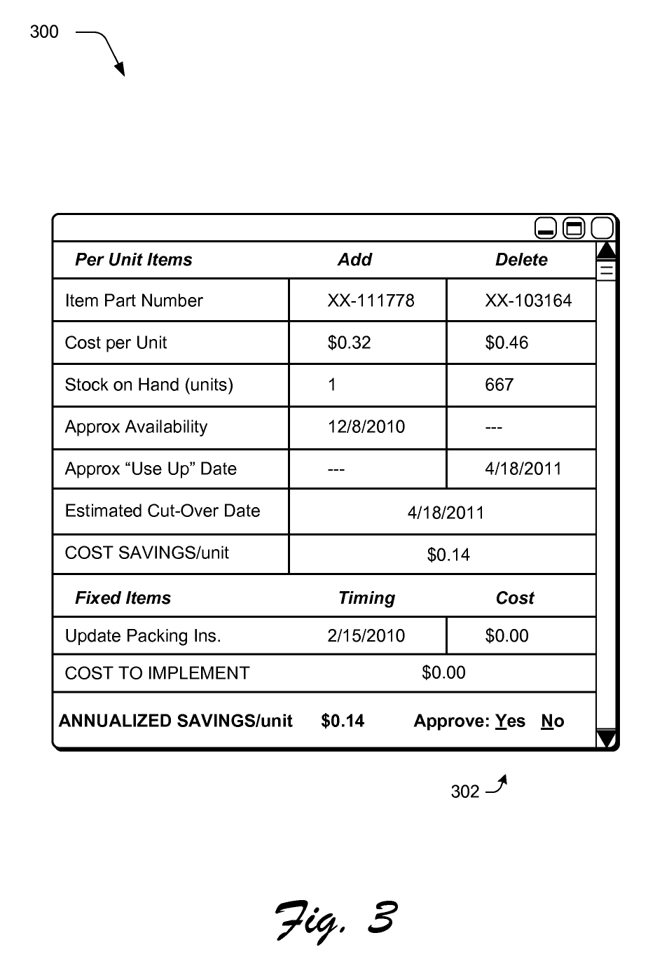

The computing device 102 is further illustrated as including a communication module 110 which is representative of functionality of the computing device 102 to communicate over the network 104, such as with the enterprise 106 and/or the outside source 108. The computing device 102 is also illustrated as including a product lifecycle management (PLM) module 112. The PLM module 112 is representative of functionality to collect product lifecycle management information and configure a user interface to include the information, an example of which is illustrated as output for display on the display device of the computing device 102. Additional examples of user interfaces may be found in relation to FIGS. 2 and 3.

As previously described, Product Lifecycle Management (PLM) techniques are used by designers and manufacturers of products to manage information across functional groups within the Enterprise. However, the process of finding information, understanding the content based on the user's function, determining the relevance of the information and deciding the actions to be taken (based upon context) using conventional PLM techniques is often inefficient, difficult, and laborious, thereby preventing a vast majority of potential participants from using the information in a productive and meaningful way. The result is that a fundamental source of information is not utilized, not leveraged effectively, and often replicated many times, which causes increased cost, time to market, significant loss of revenue and lack of competitive advantage.

The PLM module 112, however, may employ techniques to collect, visualize, and navigate structured product life management metadata 114 and unstructured transaction information 116 from a variety of sources both within an enterprise 106 and outside the enterprise 106, which is illustrated as the outside source 108. Further, the PLM module 112 may present this information in real time or near real time (e.g., low latency) contextual view via a customizable user interface.

The PLM module 112, for instance, may configure a user interface based on a user's job function (and therefore work style) within the enterprise 106, such as by employing a format and terminology chosen for the job function. Thus, a user of the computing device 102 may interact with the PLM module 112 to view PLM information and make business decisions in a readily understandable and intuitive manner as opposed to conventional techniques that relied on specialized training, e.g., knowledge of application boundaries and integrated systems that were designed around the information structure.

Accordingly, the PLM module 112 may collect a variety of different product lifecycle management information. Examples of this information include enterprise product lifecycle management information 118 and outside product lifecycle management information 120 which are illustrated as stored in respective storage devices 122, 124 of the enterprise 106 and the outside source 108. The enterprise product lifecycle management information 118 may take a variety of different forms. For example, this information may include costing information 126, environmental compliance information 128, inventory management information 130, quality control information 132, reliability information 134, and other information 136 related to the enterprise 106. Likewise, the outside product lifecycle management information 120 may take a variety of forms, such as vendor management information 138, vendor approval information 140, standards compliance information 142, legal compliance information 144, and other information 146 that may be obtained from an outside source 108

In collecting this information, the PLM module 112 may build an image of PLM information and do so with enforced security rules. Additionally, the PLM module 112 may support use of graphical query techniques to overlay business intelligence capabilities onto the PLM information. Further, the PLM module 112 may include an ability to select both the information to be displayed as well as a presentation format and terminology of the information. This selection may be based on a variety of factors, such as a job function of a user that is to view the information.

The job function, for instance, may be used to configure the information to match a perspective and decision-making criteria of specific users, functional groups, and teams within the enterprise 106. Thus, the job function may be based on a variety of different factors, such as management level (e.g., approved decision making capability), level of technical expertise, membership in functional groups in an enterprise (e.g., engineering, sales, marketing, legal, management, senior executive level), and so forth. This resolves the issue of the “one size fits all” approach of conventional techniques that were difficult to comprehend by a majority of users and thus could involve specialized training.

The PLM module 112 may then output the information via a user interface for viewing by a user in a variety of ways. For example, the PLM module 112 may combine information from a variety of system both inside and outside of the enterprise 106. The ability to combine information from a variety of different systems into a single view may be used to improve decision making based upon business context. Further, this information may be queried to locate desired information that otherwise would not be apparent within conventional PLM techniques due to its highly structured and hierarchical information design and associated user interface that mimicked the design.

Combining the above described capabilities may result in a comprehensive solution that is readily understandable by typical users and yet expand a range of information that may be provided. As such, the size and scope of the user base may extend significantly beyond that of conventional PLM techniques. For example, senior management may effectively monitor product development status using a one-click dashboard approach, which was not available in conventional PLM techniques. Examples of user interfaces that may be configured according to the PLM techniques described herein may be found in relation to FIGS. 2 and 3.

FIG. 2 is an illustration of a user interface 200 in an example implementation that includes product lifecycle management information for a product. The user interface 200 in this example may be output by the PLM module 112 of FIG. 1. The user interface 200 includes columns listed “part,” “info,” and “usage” to organize PLM information that relates to a specific product, which in this instance is a switch.

The part column includes information that identifies the part, such as a part number, type of device, origination, size, and a link to a specification sheet in case additional information is desired. The info column includes a price of the part, a number of vendors for the product (e.g., including preferred and other), compliance status of the product regarding standards, environmental considerations, and legal considerations (e.g., compliance with Federal, State, and/or local legal considerations), and an indication of quality. The usage column indicates a development stage of the product and includes information about anticipated uses and potential users of the product. Thus, the user interface 200 in this example is configured as a graphical user interface having a format and terminology that are readily understood by a common user. A user interface may also be configured to include an option to provide an input regarding a business decision, an example of which may be found in relation to the following figure.

FIG. 3 is an illustration of an example user interface 300 that includes an option to input a result of a business decision along with information that has a format and terminology chosen based on a job function of a user that is to make the decision. The user interface 300 in this example is configured to include information that relates to a change of a part for a product and includes two sections, a “Per Unit Items” section that includes information relating to the parts to be added and deleted in respective columns.

The user interface 300 also includes a “Fixed Items” section that references other issues to be fixed and a cost of fixing those issues that are a result of the proposed change. In the illustrated example, the fix is to update packing instructions.

The PLM module 112 in this example collects the information for this engineering change order and displays information that is relevant to making a business decision. Further, the PLM module 112 may automatically generate a portion of this information from the collected information. For instance, to determine the estimated cut-over date of “Apr. 18, 2011” the PLM module 112 may compare a date of availability of the new part (e.g., Dec. 8, 2010), a “use up” date for the old part (e.g., Apr. 18, 2010, which may be based on the stock on hand and rate of consumption), and a date to fix items related to the change (e.g., Feb. 15, 2010 to update the packing instructions). Additionally, the PLM module 122 may compare the cost savings per unit and the cost to implement the fixed items to arrive at an annualized saving per unit of “$0.14.”

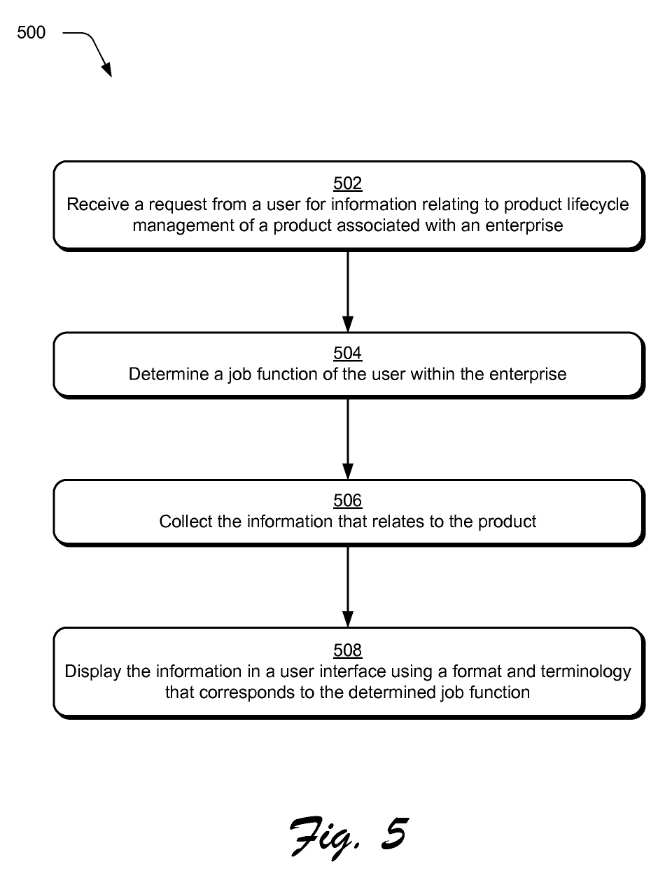

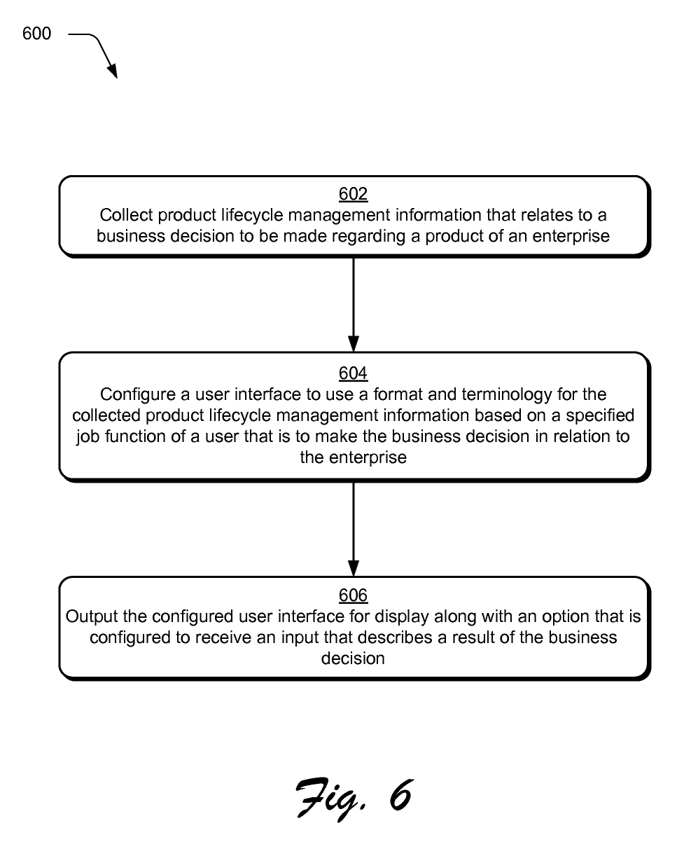

Thus, a user may view the user interface 300 may readily ascertain information that is related to making a business decision of whether to replace parts in a product. An option 302 may then be provided to specify an input that describes a result of the business decision, which in this instance is a “yes” or no” that may be made using a cursor control device. The option 302 may take a variety of other forms, such as check boxes, text entry portions, and so on. Thus, the user interface may be configured in a variety of ways, further discussion of which may be found in relation to FIGS. 5 and 6.

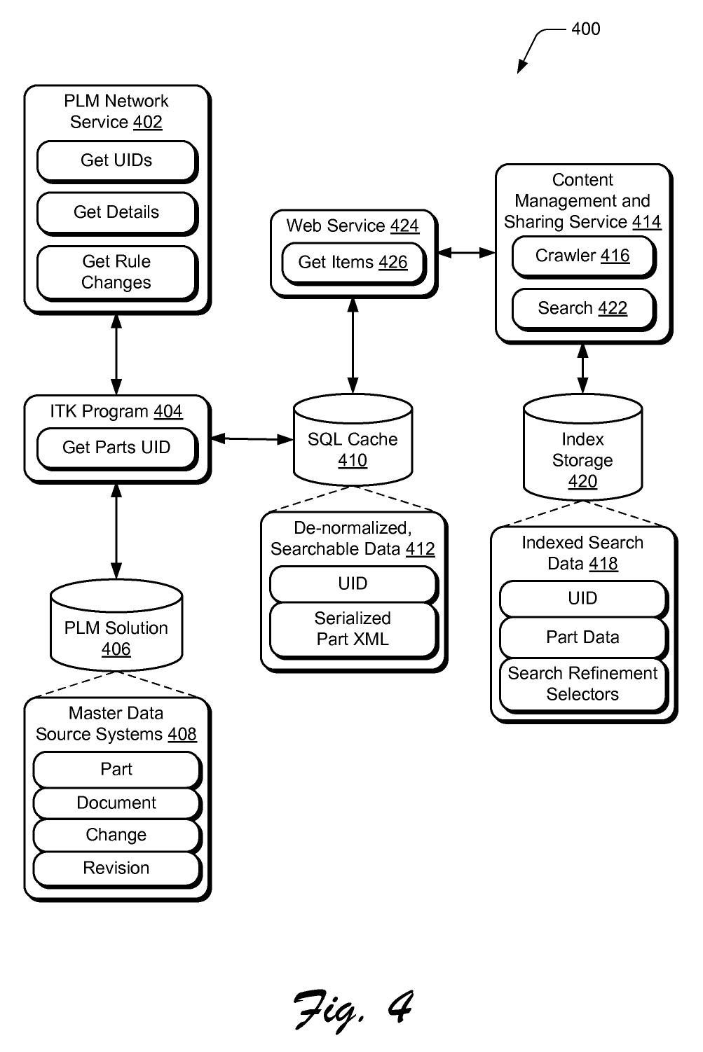

FIG. 4 is an illustration of an example system 400 that is operable to support one or more of the product lifecycle management techniques described herein. The system includes a PLM network service 402. The PLM network service 402 is configured to invoke an ITK program 404 to get unique identifiers (UIDs) of products and parts of products, details, rule changes, and so forth. The UIDs, for instance, may be written to files on a server along with corresponding information for parsing by the ITK program 404.

The ITK program 404 is configured to connect to PLM solution 406 storage service to access master data source systems 408 to obtain parts, related documents, change information, and revision information. The ITK program 404 may then employ one or more security techniques to encrypt and then push the information to a SQL cache 410 such that the SQL cache 410 may contain “de-normalized” searchable data 412 which may include universal identifiers and a serialized part XML.

The system 400 is further illustrated as including a content management and sharing service 414, an example of which is a SHAREPOINT service (which is a trademark of the Microsoft, Corp., Redmond, Wash.). The content management and sharing service 414 is illustrated as including a crawler 416 that is representative of functionality to crawl the SQL cache 410 to generate an index 418 illustrated as stored in index storage 420. The content management and sharing service 414 may then support a search 422 service such that users may search against the indexed search data 418 (e.g., users of a web service 424), select items from search results, and responsive to the selection cause a call to be initiated to obtain additional information.

The system 400 is further illustrated as including a web service 424 that may provide a user interface to access the different parts of the system 400. For example, the web service 424 may be configured to call the ITK program 404 using a get items 426 method to obtain delta lists that references parts which have changed since the last time such a list was supplied. The web service 424 may also call the ITK program 404 to obtain information that described changes to rules and corresponding parts that have been affected by the changes. The web service 424 may further provide updated files that contain UIDs back to the ITK program 404, such as to reflect changes made through interaction with a user interface. In this way, the system 400 may obtain information from a variety of different sources and expose this information in a user interface, further discussion of which may be found in relation to the following procedure section.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, a computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

### Example Procedures

The following discussion describes product lifecycle management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the user interfaces 200, 300 of FIGS. 2 and 3, and the system 400 of FIG. 4, respectively.

FIG. 5 depicts a procedure 500 in an example implementation in which information is displayed in a user interface using a format and terminology that corresponds to a determined job function. A request is received from a user for information relating to product lifecycle management of a product associated with an enterprise (block 502). A variety of products may be represented in a product lifecycle management system, such as physical products as well as non-physical products such as software.

A job function of the user within the enterprise is determined (block 504). For example, job functions may include engineers (e.g., mechanical, electrical, software) and well as information workers such as product manager, procurement manager, production manager, product marketing, technical writers, and so on. Accordingly, each of these job functions may have a terminology that is particular to the job function and thus is readily understood by those having that job function.

Information that relates to the product is collected (block 506) and displayed in a user interface using a format and terminology that corresponds to the determined job function (block 508). Thus, the PLM module 112 may configure a user interface based on a job function of a user that is to view it. Continuing with the previous example, a marketing writer may be more interested in general descriptions and images of a product whereas an engineer may be more interested in a product identifiers and technical specifications. In this way, the PLM module 112 may support a user interface to display product lifecycle management information that may be readily understood by a wide variety of users. The user interface may also be configured to use this information in support of a business decision and receive an input that describes a result of that decision, an example of which may be found in relation to the following figure.

FIG. 6 depicts a procedure 600 in an example implementation in which an option is displayed along with product lifecycle management information to receive an input that describes a result of a business decision. Product lifecycle management information is collected that relates to a business decision to be made regarding a product of an enterprise (block 602). The PLM module 112, for instance, may receive in input that describes a change to be made to a part of a product. Responsive to this, the PLM module 112 may obtain product lifecycle management information that relates to this change, such as legal and environmental compliance information, inventory and rate of consumption, part availability, cost, and so on.

A user interface is configured to use a format and terminology for the collected product lifecycle management information based on a specified job function of a user that is to make the business decision in relation to the enterprise (block 604). The user interface, for instance, may configure the user interface to include a format to present the information that is relevant to the business decision. Additionally, this user interface may also include terminology that is particular to a job function such that the user interface may use different terminology depending on the job function.

The configured user interface is output for display along with an option in that is configured to receive an input that describes a result of the business decision (block 606). As shown in FIG. 3, for instance, an option 302 may be included such that a user that view the user interface may read information that is relevant to the business decision, make the decision, and input a result of the decision. A variety of different option configurations are contemplated, such as check boxes, text input portions, gesture recognition, and so forth.

### Example Device

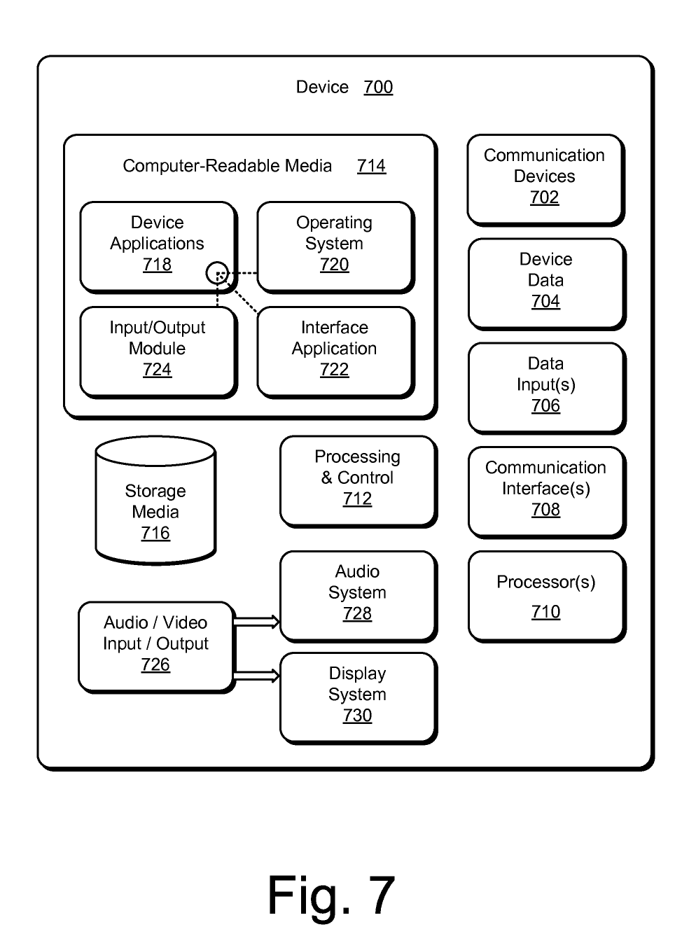

FIG. 7 illustrates various components of an example device 700 that can be implemented as any type of computing device as described with reference to FIGS. 1 and 4 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the gesture techniques described herein. In this example, the device applications 718 include an interface application 722 and an input/output module 724 (which may be the same or different as input/output module 114) that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof. Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computers, the method comprising:
receiving a request from a user for information relating to product lifecycle management of a product associated with an enterprise;
determining a job function of the user within the enterprise;
collecting the information that relates to the product; and
displaying the information in a user interface using a format and terminology that corresponds to the determined job function.

2. A method as described in claim 1, wherein the information includes structured product life management metadata and unstructured transaction information related to the product.

3. A method as described in claim 1, wherein the information further includes collecting additional information that is to be utilized in conjunction with a decision that relates to the product and the displaying includes displaying the additional information using a format that corresponds to the determined job function.

4. A method as described in claim 3, wherein the displaying includes providing an option in the user interface that is configured to receive an input that describes a result of the decision made by the user.

5. A method as described in claim 1, wherein the collecting is based at least in part on the determined job function.

6. A method as described in claim 1, wherein the job function is based at least in part on management level within the enterprise.

7. A method as described in claim 1, wherein at least one said job function causes display of the information from different hierarchical levels of the enterprise than another said job function.

8. A method as described in claim 1, wherein the job function is based at least in part on functional group within the enterprise.

9. A method as described in claim 8, wherein one or more of the functional groups indicate a corresponding level of technical expertise.

10. A method as described in claim 8, wherein the functional groups include an engineering functional group, a sales functional group, a procurement functional group, an environmental compliance functional group, a legal functional group, a marketing functional group, or a management functional group.

11. A method as described in claim 1, wherein the collecting includes obtaining at least part of the information external to the enterprise.

12. A method as described in claim 1, wherein the collecting and the displaying are repeated to update the user interface to include at least one item of the information that has changed.

13. A method implemented by one or more computers, the method comprising:
collecting product lifecycle management information that relates to a business decision to be made regarding a product of an enterprise;
configuring a user interface to use a format and terminology for the collected product lifecycle management information based on a specified job function of a user that is to make the business decision in relation to the enterprise; and
outputting the configured user interface for display along with an option that is configured to receive an input that describes a result of the business decision.

14. A method as described in claim 13, wherein the collecting is performed responsive to receipt of an input specifying the business decision to be made and the product to which the business decision relates.

15. A method as described in claim 13, wherein the collecting is performed to include at least one item of information that is obtained outside of the enterprise.

16. A method as described in claim 13, wherein the collecting is performed to locate product lifecycle management information based on the specified job function of the user.

17. A method as described in claim 13, wherein the job function is based at least in part on management level within the enterprise.

18. A method as described in claim 13, wherein the job function is based at least in part on functional group within the enterprise, wherein one or more of the functional groups indicate a corresponding level of technical expertise.

19. One or more computer-readable media comprising computer executable instructions that, responsive to execution by one or more computing devices, causes the one or more computing devices to output a user interface including:
information related to product lifecycle management of a product associated with an enterprise, the information collected based at least in part on a job function of a user that is to make a business decision related to the product and the information configured using a format and terminology based on the job function; and
an option to specify a result of the business decision.

20. One or more computer-readable media as described in claim 19, wherein the information includes structured product life management metadata and unstructured transaction information related to the product.
